(19) United States
(12) Patent Application Publication
(10) Pub. No.: US 2009/0326906 A1
(43) Pub. Date: Dec. 31, 2009

(54) VERIFICATION SUPPORT APPARATUS, VERIFICATION SUPPORT METHOD, AND COMPUTER PRODUCT

(75) Inventors: Akio MATSUDA, Kawasaki (JP); Ryosuke Oishi, Kawasaki (JP); Qiang Zhu, Yamato (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/372,816

(22) Filed: Feb. 18, 2009

(30) Foreign Application Priority Data
Jun. 27, 2008 (JP) 2008-168980

(51) Int. Cl. G06F 9/44

(52) U.S. Cl. 703/21

(57) ABSTRACT

A computer-readable recording medium stores therein a verification support program that causes a computer to execute selecting arbitrarily a use case from a use case diagram for a verification target; extracting a precondition and a postcondition of the use case selected at the selecting; and converting, to a Kripke model, a finite state machine model corresponding to the use case selected at the selecting. The verification support program further causes the computer to execute specifying, based on the precondition and the postcondition extracted at the extracting, a Kripke initial state, a Kripke precondition, and a Kripke postcondition of the Kripke model obtained at the converting; and generating, based on the Kripke precondition and the Kripke postcondition specified at the specifying, a Kripke property of the use case selected at the selecting.

### CROSS REFERENCE TO RELATED APPLICATIONS

This application is based upon and claims the benefit of priority of the prior Japanese Patent Application No. 2008-168980, filed on Jun. 27, 2008, the entire contents of which are incorporated herein by reference.

### FIELD

The embodiment discussed herein is related to automatic generation of test items from specifications of large scale integration (LSI).

### BACKGROUND

Conventionally in LSI design, although there has been a demand for increased operating efficiency by shortening the design period, proper operation of the LSI must be verified. In particular, this verification is important to maintain a high quality of LSIs so that the LSIs are highly-functional, fast, and power-thrifty.

To conduct such verification, there are tools that automatically generate test items from functional specifications (refer to Japanese Laid-Open Patent Application Publication No. 2006-209521, for example); automatically generate test timing data (refer to Japanese Laid-Open Patent Application Publication No. H5-215819, for example); generate a verification program directly from test specifications representing requirement specifications (refer to Japanese Laid-Open Patent Application Publication No. H6-195216, for example); or generate test items from typical operation patterns (refer to Japanese Laid-Open Patent Application Publication No. 2003-108405, for example).

In addition to verification tools, specification based test (SBT) techniques are used to conduct verification. An SBT technique generates test items from formal specifications. Specifically, the SBT technique automatically generates test items by providing a finite state machine model representing specifications of a verification target and coverage standards (state coverage, transition coverage, and path coverage) that are not used with the foregoing verification tool.

FIG. 9 is a diagram for explaining a finite state machine model for a verification target. In a finite state machine model 900 depicted in FIG. 9, reference codes “S0”, “S1”, and “S2” refer to states, and terms “reset”, “!reset&mode=0” and “!reset&mode=1” refer to transitions.

FIG. 10 is a diagram for explaining state coverage. In FIG. 10, the left column indicates sequences (aggregation of paths) covered by state coverage generated by a conventional SBT technique, and the right column indicates paths not covered by the state coverage.

FIG. 11 is a diagram for explaining transition coverage. In FIG. 11, the left column indicates sequences (aggregation of paths) covered by transition coverage generated by a conventional SBT technique, and the right column indicates paths not covered by the transition coverage.

FIG. 12 is a diagram for explaining path coverage. FIG. 12 depicts sequences (aggregation of paths) covered by path coverage from the state “S0” to the state “S0”.

The state coverage depicted in FIG. 10 cannot cover the state S2 as indicated in the right column. Thus, state coverage has a problem in that a path(s) may not be covered. In addition, the transition coverage depicted in FIG. 11 cannot cover the transition “reset” with a self-loop in the state “S0” as indicated in the right column. Thus, as with state coverage, transition coverage has a problem in that a path(s) may not be covered.

Further, as depicted in FIG. 12, although path coverage can cover all paths, a problem exists in that the number of paths becomes infinite if loops are included, and thus verifying all the paths is not realistic. The number of paths can be made finite by imposing a restriction that one loop cannot be passed through twice. However, this causes a problem in that it is not possible to specify which state is a start and which state is an end.

### SUMMARY

According to an aspect of an embodiment, a computer-readable recording medium stores therein a verification support program that causes a computer to execute selecting arbitrarily a use case from a use case diagram for a verification target; extracting a precondition and a postcondition of the use case selected at the selecting; and converting, to a Kripke model, a finite state machine model corresponding to the use case selected at the selecting. The verification support program further causes the computer to execute specifying, based on the precondition and the postcondition extracted at the extracting, a Kripke initial state, a Kripke precondition, and a Kripke postcondition of the Kripke model obtained at the converting; and generating, based on the Kripke precondition and the Kripke postcondition specified at the specifying, a Kripke property of the use case selected at the selecting.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of an overview of the disclosed technology;

FIG. 2 is a diagram depicting details concerning a use case 1;

FIG. 3 is a block diagram of a verification support apparatus according to an embodiment;

FIG. 4 is a functional diagram of the verification support apparatus according to the embodiment;

FIG. 5 is a diagram for explaining an example of conversion from a finite state machine model to a Kripke model;

FIG. 6 is a diagram depicting an example of description of a trap property for use case state coverage (UCSC);

FIG. 7 is a diagram depicting an example of description of a trap property for use case transition coverage (UCTC);

FIG. 8 is a flowchart of a verification support process of the verification support apparatus;

FIG. 9 is a diagram for explaining a finite state machine model for a verification target;

FIG. 10 is a diagram for explaining state coverage;

FIG. 11 is a diagram for explaining transition coverage; and

FIG. 12 is a diagram for explaining path coverage.

### DESCRIPTION OF EMBODIMENT(S)

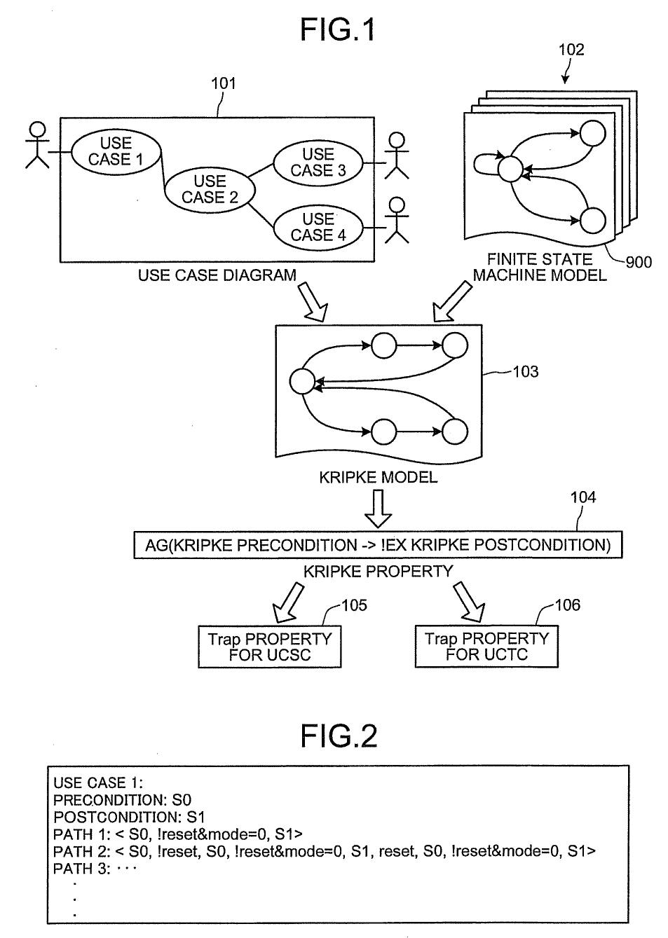

Preferred embodiments of the present invention will be explained with reference to the accompanying drawings. FIG. 1 is a diagram of an overview of the disclosed technology. According to the technology, a use case (e.g. use case 1) is selected from a use case diagram 101 for a verification target, and a finite state machine model 900 corresponding to the use case 1 is selected from a finite state machine model group 102 representing specifications of the verification target.

The selected finite state machine model 900 is converted to a Kripke model 103. The Kripke model 103 is a model of transitions in the finite state machine model 900 to states. From the Kripke model 103, a Kripke property is generated. Reference numeral 104 denotes a constraint expression of the Kripke property.

Upon determination of the Kripke property, a trap property 105 for UCSC and a trap property 106 for UCTC can be obtained. The term “property” here refers to an expression of a constraint condition such as “a is larger than b”, for example.

The Kripke property is a property obtained from the Kripke model 103. The trap property refers to an expression of a constraint condition for an original property such as “test is conducted/not conducted when the original property (here, the Kripke property) is satisfied”. In the embodiment, the trap property is expressed by an aggregation of paths.

As depicted in FIG. 1, if the verification target is expressed in the use case diagram 101, the verification target includes use cases representing functions to be implemented. Each of the use cases has a precondition, a postcondition, and a path(s). The precondition here refers to a condition that becomes true for initiation of a use case. The postcondition refers to a condition that becomes true after execution of a use case. The path constitutes a sequence from the precondition to the postcondition. That is, the use cases are an aggregation of all sequences from a precondition to a postcondition.

FIG. 2 is a diagram depicting details concerning the use case 1. As depicted in FIG. 2, a path 1 and a path 2 satisfy a precondition (S0) and a postcondition (S1).

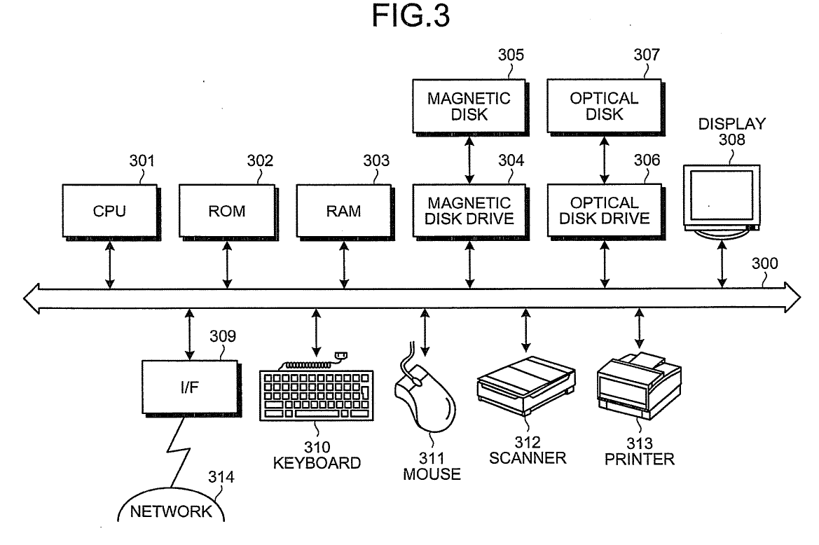

FIG. 3 is a block diagram of a verification support apparatus according to an embodiment. As depicted in FIG. 3, a verification support apparatus includes a central processing unit (CPU) 301, a read-only memory (ROM) 302, a random access memory (RAM) 303, a magnetic disc drive 304, a magnetic disc 305, an optical disc drive 306, an optical disc 307, a display 308, a interface (I/F) 309, a keyboard 310, a mouse 311, a scanner 312, and a printer 313, connected to one another by way of a bus 300.

The CPU 301 governs overall control of the verification support apparatus. The ROM 302 stores therein programs such as a boot program. The RAM 303 is used as a work area of the CPU 301. The magnetic disc drive 304, under the control of the CPU 301, controls reading/writing of data from/to the magnetic disc 305. The magnetic disc 305 stores therein the data written under control of the magnetic disc drive 304.

The optical disc drive 306, under the control of the CPU 301, controls reading/writing of data from/to the optical disc 307. The optical disc 307 stores therein the data written under control of the optical disc drive 306, the data being read by a computer.

The display 308 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 308.

The I/F 309 is connected to a network 314 such as a local area network (LAN), a wide area network (WAN), and the Internet through a communication line and is connected to other apparatuses through the network 314. The I/F 309 administers an internal interface with the network 314 and controls the input/output of data from/to external apparatuses. For example, a modem or a LAN adaptor may be employed as the I/F 309.

The keyboard 310 includes, for example, keys for inputting letters, numerals, and various instructions and performs the input of data. Alternatively, a touch-panel-type input pad or numeric keypad, etc. may be adopted. The mouse 311 performs the movement of the cursor, selection of a region, or movement and size change of windows. A track ball or a joy stick may be adopted provided each respectively has a function similar to a pointing device.

The scanner 312 optically reads an image and takes in the image data into the IP model creating apparatus. The scanner 312 may have an optical character recognition (OCR) function as well. The printer 313 prints image data and text data. The printer 313 may be, for example, a laser printer or an ink jet printer.

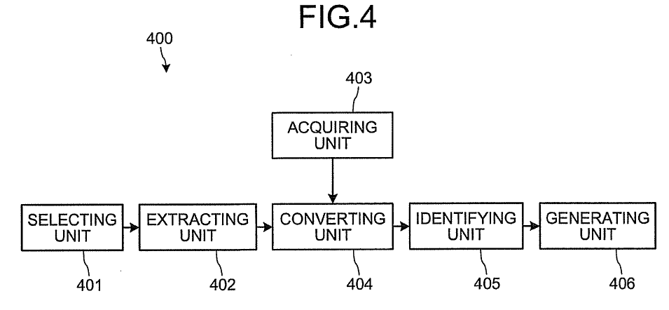

FIG. 4 is a functional diagram of the verification support apparatus according to the embodiment. A verification support apparatus 400 includes a selecting unit 401, an extracting unit 402, an acquiring unit 403, a converting unit 404, a specifying unit 405, and a generating unit 406. Functions of the selecting unit 401 to the generating unit 406 constitute a control unit and are implemented by causing the CPU 301 to execute programs stored in a storage area such as the ROM 302, the RAM 303, the magnetic disk 305, or the optical disk 307, or through the I/F 309, as depicted in FIG. 3, for example.

The selecting unit 401 has a function of selecting an arbitrary use case from the use case diagram 101 for the verification target. Specifically, the selecting unit 401 selects a use case that has not yet been selected, for example. The selecting unit 401 enables comprehensive selection of all the use cases in the use case diagram 101. Hereinafter, the use case selected by the selecting unit 401 is referred to as “selected use case”. The selected use case is stored in a storage area such as the RAM 303, the magnetic disk 305, or the optical disk 307.

The extracting unit 402 has a function of extracting a precondition and a postcondition of the selected use case. The use case includes descriptions of the precondition and the postcondition as depicted in FIG. 2 and the extracting unit 402 extracts the descriptions. The extracted precondition and postcondition are stored in a storage area such as the RAM 303, the magnetic disk 305, or the optical disk 307.

The acquiring unit 403 has a function of acquiring the finite state machine model 900 corresponding to the selected use case. The finite state machine model 900 represents specifications of the use case for the verification target. Correspondence between the finite state machine models 900 and the use cases is determined by a person in charge of verification. The acquired finite state machine model 900 is stored in a storage area such as the RAM 303, the magnetic disk 305, or the optical disk 307.

The converting unit 404 has a function of converting the finite state machine model 900 corresponding to the selected use case to the Kripke model 103. The Kripke model 103 is a model based on transitions in the finite state machine model 900.

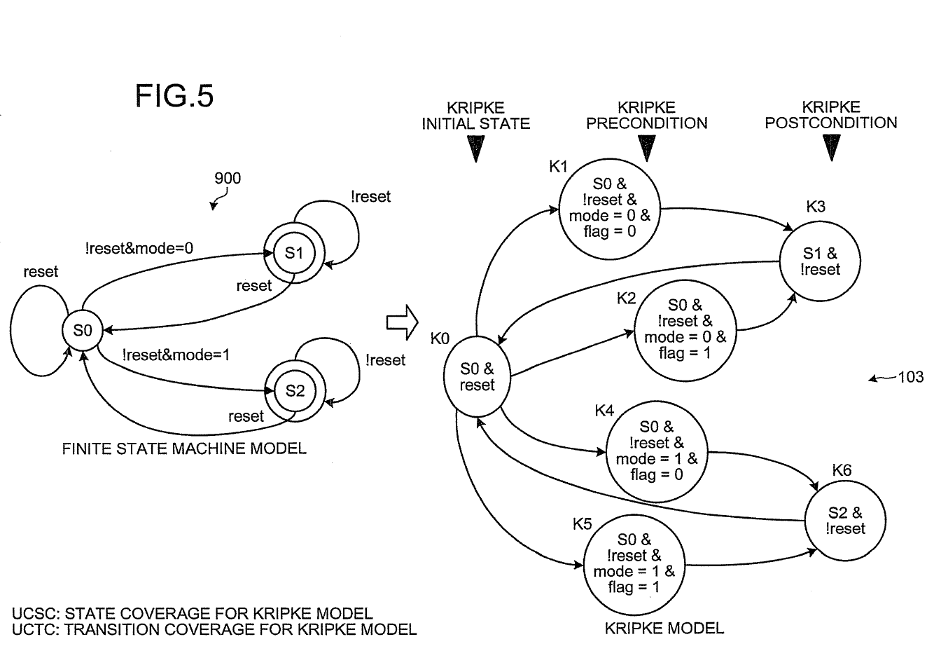

FIG. 5 is a diagram for explaining an example of conversion from the finite state machine model 900 to the Kripke model 103. In the Kripke model 103 depicted in FIG. 5, a state “K0” is a state having a transition “reset” in a state “S0” and the state “S0” as a source of the transition. A state “K1” is a state having a transition “!reset&mode=0” in the state “S0”, “flag=0”, and the state “S0” as a source of the transition.

A state “K2” is a state having the transition “!rest&mode=0” in the state “S0”, “flag=1”, and the state “S0” as a source of the transition. A state “K3” is a transition “!reset” in a state “S1” and the state “S1” as a source of the transition.

A state “K4” is a state having a transition “!reset&mode=1” in the state “S0”, “flag=0”, and the state “S0” as a source of the transition. A state “K5” is a state having the transition “!reset&mode=1” in the state “S0”, “flag=1”, and the state “S0” as a source of the transition. A state “K6” is a state having a transition “!reset” in a state “S2” and the state “S1” as a source of the transition.

Since the conversion from the finite state machine model 900 to the Kripke model 103 is a publicly known technique, any tool can be used to convert the finite state machine model 900 to the Kripke model 103. The Kripke model 103 is stored in a storage area such as the RAM 303, the magnetic disk 305, or the optical disk 307.

The specifying unit 405 has a function of specifying a Kripke initial state, a Kripke precondition, and a Kripke postcondition of the Kripke model 103 converted by the converting unit 404, based on the precondition and the postcondition extracted by the extracting unit 402. The Kripke initial state refers to an initial state in the Kripke model 103.

The Kripke precondition refers to a state indicative of a precondition in the Kripke model 103. The Kripke postcondition refers to a state indicative of a postcondition in the Kripke model 103. The precondition of the use case 1 is the state “S0” which is maintained by the transition “reset”. Therefore, the state “K1”, which is “S0&reset”, is the Kripke initial state.

Further, the postcondition of the use case 1 is the state “S1” which is maintained by the transition “!reset”. Therefore, the state “K3”, which is “S1&!reset”, is the Kripke postcondition. Moreover, since the state “K3” is the Kripke postcondition, the states “K1” and “K2”, as sources of the transitions, are the Kripke preconditions.

If the postcondition of the use case 1 is “S1 or S2”, the Kripke postcondition is “K3 or K6” and the Kripke precondition is “K1 or K2 or K3 or K4”. The specified Kripke initial state, Kripke precondition and Kripke postcondition are stored in a storage area such as the RAM 303, the magnetic disk 305, or the optical disk 307.

In FIG. 4, the generating unit 406 has a function of generating a Kripke property of the selected use case, based on the Kripke precondition and Kripke postcondition specified by the specifying unit 405. Specifically, the generating unit 406 generates a Kripke property of the selected use case with which all the states covering the Kripke precondition to the Kripke postcondition are passed.

This Kripke property is called Kripke property for UCSC. In addition, the generating unit 406 generates a Kripke property of the selected use case with which all the transitions covering the Kripke precondition to the Kripke postcondition are passed. This Kripke property is called Kripke property for UCTC.

A Kripke property is expressed by a constraint expression “AG(Kripke precondition→!EX Kripke postcondition)”. In the expression, “AG” and “EX” are sets of operators in computational tree logic. The Kripke precondition and the Kripke postcondition are substituted into the Kripke property constraint expression to thereby generate a Kripke property.

Specifically, in generating a Kripke property for UCSC, a logical OR of all the Kripke preconditions and the Kripke postcondition are substituted into the constraint expression of a Kripke property. For example, if the Kripke precondition is the state “K1 or K2” and the Kripke postcondition is the state “K3”, the Kripke property for UCSC is “AG(K1 or K2)→!EX(K3)”, that is, “AG(!reset)→!EX(S1)”.

Further, in generating a Kripke property for UCTC, a logical OR of all the Kripke preconditions, a destination of transition from the Kripke initial state, and the Kripke postcondition are substituted into the expression. For example, if the Kripke precondition is the state “K1 or K2” and the Kripke postcondition is the state “K3”, the Kripke property for UCTC is “AG(!reset&K1&K2)→!EX(S1)”. The generated Kripke property is stored in a storage area such as the RAM 303, the magnetic disk 305, or the optical disk 307.

In addition, the generating unit 406 has a function of generating a trap property based on a Kripke property. Specifically, a trap property is returned by providing a Kripke property to a publicly known verification tool, for example.

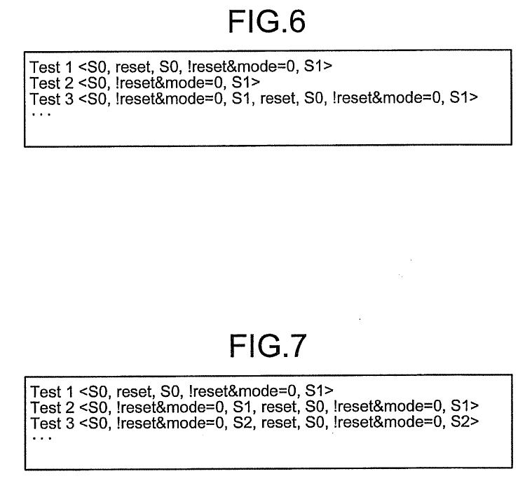

FIG. 6 is a diagram depicting an example of description of the trap property for UCSC 105. Paths in test 1 to test 3 depicted in FIG. 6 are sequences of valid examples that include the precondition “S0” and postcondition “S1” for the use case 1. If a path does not include both the precondition “S0” and the postcondition “S1”, the path is a sequence of an invalid example.

FIG. 7 is a diagram depicting an example of description of a trap property for UCTC 106. Paths in test 1 and test 2 depicted in FIG. 7 are sequences of valid examples that include the precondition “S0” and the postcondition “S1” for the use case 1. If a path does not include both the precondition “S0” and the postcondition “S1”, the path is a sequence of an invalid example. A path in test 3 is a sequence of an invalid example that does not include the postcondition “S1”.

The generated trap properties are stored in a storage area such as the RAM 303, the magnetic disk 305, or the optical disk 307. The Kripke properties and the trap properties can be transmitted externally such as by display on the display 308 or printing by the printer 313, as appropriate.

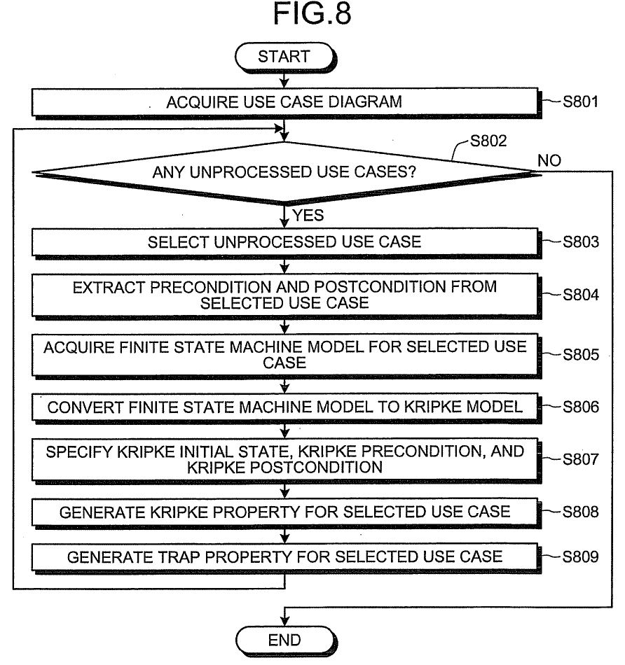

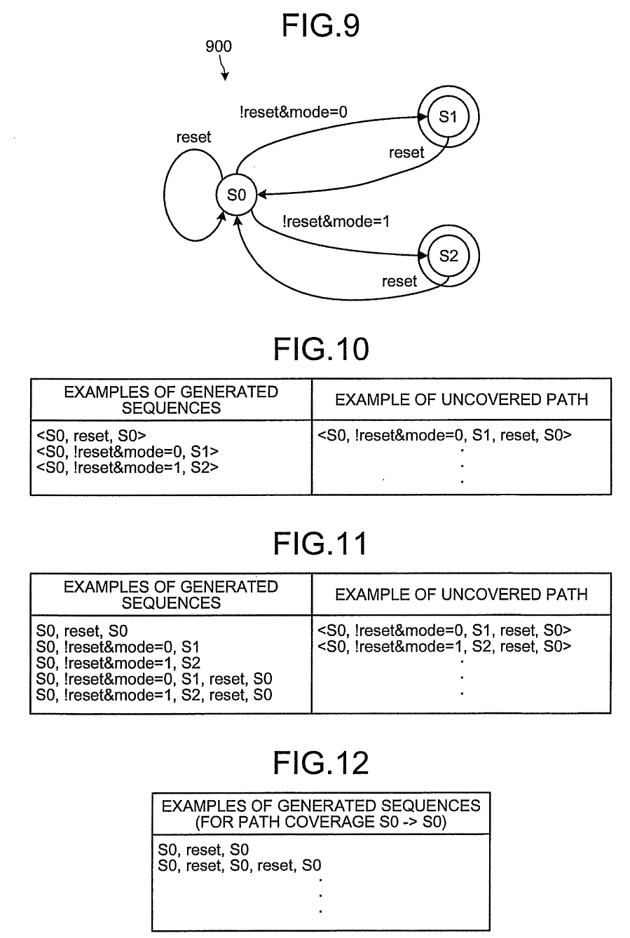

FIG. 8 is a flowchart of a verification support process of the verification support apparatus 400. The verification support apparatus 400 acquires the use case diagram 101 for the verification target (step S801) and determines whether there is any unprocessed use case (step S802). If an unprocessed use case is present (step S802: YES), the selecting unit 401 selects an unprocessed use case (step S803).

The extracting unit 402 extracts a precondition and a postcondition from the selected use case (step S804). Subsequently, the acquiring unit 403 acquires the finite state machine model 900 for the selected use case (step S805), and the converting unit 404 converts the finite state machine model 900 to the Kripke model 103 (step S806) The specifying unit 405 specifies the Kripke initial state, the Kripke precondition, and the Kripke postcondition (step S807), and the generating unit 406 generates a Kripke property of the selected use case (step S808). The generating unit 406 provides the generated Kripke property to a formal verification tool to thereby generate a trap property of the selected use case (step S809). Subsequently, the process returns to step S802. If no unprocessed use case is present at step S802 (step S802: NO), the verification support apparatus 400 terminates a series of verification support processes.

With regard to loop definition in the finite state machine model 900, if one transition takes place multiple times (for example, if one loop is passed through twice: <S0, reset, S0, reset, S0>, or if one loop is not passed through twice: <So, reset, S0, !reset&mode=0, S1, reset, S0>), some constraint may be imposed such as “no loop is permitted”, “a loop is permitted once”, or “a loop is permitted a designated number of times”.

In this manner, a precondition and a postcondition of a use case are used with respect to state coverage and transition coverage under a conventional SBT technique; hence, it is possible to produce a test covering paths between the precondition and the postcondition of the use case and also improve the quality of the test items. Further, with respect to conventional path coverage, there is a high possibility that actual test items can be narrowed down, thereby shortening the period of verification. Moreover, it is further possible to cover even some of paths that can be only covered by path coverage. As explained above, according to the embodiment, it is possible to provide complete coverage and improved quality of test items.

The verification support method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium storing therein a verification support program that causes a computer to execute:
selecting arbitrarily a use case from a use case diagram for a verification target;
extracting a precondition and a postcondition of the use case selected at the selecting;
converting, to a Kripke model, a finite state machine model corresponding to the use case selected at the selecting;
specifying, based on the precondition and the postcondition extracted at the extracting, a Kripke initial state, a Kripke precondition, and a Kripke postcondition of the Kripke model obtained at the converting; and
generating, based on the Kripke precondition and the Kripke postcondition specified at the specifying, a Kripke property of the use case selected at the selecting.

2. The computer-readable recording medium according to claim 1, wherein the generating includes generating a Kripke property of the use case selected at the selecting and with which all states from the Kripke precondition to the Kripke postcondition are passed.

3. The computer-readable recording medium according to claim 1, wherein the generating includes generating a Kripke property of the use case selected at the selecting and with which all transitions from the Kripke precondition to the Kripke postcondition are passed.

4. The computer-readable recording medium according to claim 1, wherein the generating includes generating a trap property of the Kripke property by providing the Kripke property to a formal verification tool.

5. A verification support apparatus comprising:
a selecting unit that arbitrarily selects a use case from a use case diagram for a verification target;
an extracting unit that extracts a precondition and a postcondition of the use case selected by the selecting unit;
a converting unit that converts, to a Kripke model, a finite state machine model corresponding to the use case selected by the selecting unit;
a specifying unit that, based on the precondition and the postcondition extracted by the extracting unit, specifies a Kripke initial state, a Kripke precondition, and a Kripke postcondition of the Kripke model obtained at the converting unit; and
a generating unit that, based on the Kripke precondition and the Kripke postcondition specified by the specifying unit, generates a Kripke property of the use case selected by the selecting unit.

6. A verification support method comprising:
selecting arbitrarily a use case from a use case diagram for a verification target;
extracting a precondition and a postcondition of the use case selected at the selecting;
converting, to a Kripke model, a finite state machine model corresponding to the use case selected at the selecting;
specifying, based on the precondition and the postcondition extracted at the extracting, a Kripke initial state, a Kripke precondition, and a Kripke postcondition of the Kripke model obtained at the converting; and
generating, based on the Kripke precondition and the Kripke postcondition specified at the specifying, a Kripke property of the use case selected at the selecting.
